(19) United States
(12) Patent Application Publication
(10) Pub. No.: US 2025/0030194 A1
(43) Pub. Date: Jan. 23, 2025

(54) PLUG CONNECTOR WITH A MOVABLE SHEATH

(71) Applicant: Murrelektronik GmbH, Oppenweiler (DE)

(72) Inventor: Heiko FEISST, Oppenweiler (DE)

(21) Appl. No.: 18/775,126

(22) Filed: Jul. 17, 2024

(30) Foreign Application Priority Data
Jul. 17, 2023 (EP) 23 185 944.8

(51) Int. Cl. H01R 13/58; H01R 13/422

(52) U.S. Cl. CPC H01R 13/5825; H01R 13/422

(57) ABSTRACT

A plug connector for forming a plug connection, including a sheath which is designed to extend at least almost over an entire length of the plug connector and to move relative to a contact carrier of the plug connector, wherein the sheath has at least one opening through which a plug connector cable can be passed, which merges into at least one contact provided on the contact carrier.

### FIELD OF THE DISCLOSURE

Embodiments of the present disclosure relate to a plug connector, in particular a circular plug connector, for forming a plug connection.

### BACKGROUND

In the following, reference is made to plug connectors or plug connections. These terms include both plugs and couplings. The idea expressly includes male and female components as well as combinations. The term plug connector may in particular also refer to a single plug.

Circular plug connectors are often used in field applications in industry. Plug connectors of the types M8, M12, ⅞″, M16, MQ15 are particularly common.

The plug connectors are typically standardized, for example in the IEC 61076-2-xxx series of standards, the last digits of the standard (abbreviated here with xxx as a placeholder) describing the design of the plug connectors.

The standards IEC 61076-2-101, IEC 61076-2-109, IEC 61076-2-111 and IEC 61076-2-113 are particularly relevant for M12 plug connectors.

Conventional circular plug connectors for field applications known from the prior art typically have a contact carrier, a threaded section and an actuating element for forming, securing and/or releasing the plug connection.

In the plug connectors known from the prior art, the actuating element is typically located near the end of the plug connector which forms the plug connection with a corresponding counterpart, for example a socket into which the plug connector is plugged. The actuating element is often, but not exclusively, a threaded sleeve which has a knurl for manual rotation and an additional tool interface for a tool, for example a hexagonal geometry.

To ensure professional installation of plug connections, many conventional systems require the use of a torque wrench which is specially adapted to the plug connector and can engage in the tool interface.

However, the prior art also includes plug connector variants known as push-pull systems. These systems make the use of tools superfluous, as a defined pressure is not achieved by a torque as in the screw variants, but by other geometric properties in the plug connector. With push-pull systems, the actuating element is either pushed or pulled for locking.

There are also systems in which locking or unlocking is achieved by a partial rotation, e.g. by a ¼ turn, in particular by means of a bayonet lock.

The plug connector types known from the prior art have in common that the position of the operating level of the actuating element is close to the plug connector end via which the plug connection is established.

In many conventional field devices, several plug connectors are arranged close to each other. As a result, the space for applying tools or for manual actuation is very limited, which makes it difficult to establish and/or release plug connections.

The object of the present disclosure is to provide a plug connector by means of which a plug connection can be established and also released again in a technically simple and safe manner, in particular also in places that are difficult to access.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

According to the present disclosure, the object is achieved by a plug connector for forming a plug connection. The plug connector comprises a sheath which is designed to extend at least almost over an entire length of the plug connector and to move relative to a contact carrier of the plug connector. The sheath has at least one opening through which a plug connector cable can be passed, which merges into at least one contact provided on the contact carrier. Preferably, the sheath has two openings, in particular a first opening through which the contact carrier is accessible for establishing a plug connection and a second opening through which the plug connector cable can be passed or is passed.

The basic idea is to use the sheath which extends over the length of the plug connector as an actuating element. This simplifies the operation of plugging and releasing a plug connection. For example, this makes it possible to apply tools, such as torque wrenches. Alternatively or additionally, manual operation to establish and/or release the plug connection can also be simplified.

The operating level of the plug connector, i.e. the area used to establish and/or release the plug connection, is therefore extended or moved away from the insertion end, via which the plug connection is formed.

The entire sheath, which extends over the entire length of the plug connector, thus assumes the function of the actuating element and is mounted so as to be movable with respect to the contact carrier. This allows a necessary rotary or linear movement to be carried out, which is required to establish, release and/or secure the plug connection. The corresponding movement can be applied to an upper end of the plug connector, i.e. the end of the plug connector facing away from the contact.

This end may be provided at one end of a plug connector housing. The plug connector housing is formed by the sheath, for example.

The “sheath, which is designed to extend at least almost over an entire length of the plug connector” is to be understood to mean that at least 75%, preferably more than 90% and particularly preferably 100% of the length of the plug connector accessible from the outside is formed by the sheath in a plugged-in state.

In a plugged-in state, the contact carrier of the plug connector is therefore at least almost completely covered by the sheath (on the outside) or surrounded by the sheath over its entire accessible length.

In other words, at least the part of the plug connector which does not engage directly into a corresponding counterpart in a plug connection is at least almost completely enclosed by the sheath.

It is in particular conceivable that a part of the contact carrier or the contact of the plug connector, which is designed to be plugged into a counterpart, for example a socket, to form a plug connection, protrudes beyond the sheath when the plug connector is not plugged in.

Of course, the sheath can also extend over the entire contact carrier and/or the contact, for example thus form a collar on the plug connector which surrounds a free end of the contact.

According to one aspect, the sheath may be designed as an adapter which can be placed on the plug connector such that the sheath fully encloses the plug connector. In particular, the adapter may be suitable for retrofitting conventional plug connectors to a plug connector according to the present disclosure.

For this purpose, the adapter can, for example, have a geometry on the inside which, when fitted, engages with a knurl or a tool interface, for example a hexagon, of the conventional plug connector and thus creates a mechanical connection.

The adapter therefore forms a sheath which encloses the conventional plug connector and can be rotated and/or displaced relative thereto.

In other words, the adapter assumes the function of the actuating element of the conventional plug connector on the outside.

In particular, the sheath may be designed in several parts, so that several sheath parts are provided which can be coupled to each other. This simplifies the assembly of the plug connector according to the present disclosure.

Preferably, the sheath is designed to be multi-part in the circumferential direction, in particular in two parts. The sheath can therefore have two sheath halves, which form the sheath in the assembled state.

If a conventional plug connector is assumed, the (two) sheath parts can be placed on the conventional plug connector and then connected to each other, for example by means of a positive, frictional and/or non-positive connection, in particular a latching and/or clip connection.

Alternatively, the sheath may also be formed in one piece over the entire length of the plug connector. This results in a mechanically particularly robust structure.

A sheath designed as an adapter can also be in one piece. It is conceivable that the one-piece sheath can be slipped over the conventional plug connector on the contact or cable side to thus create a plug connector according to the present disclosure. For this purpose, the sheath can be made of an elastic material, which nevertheless has sufficient rigidity to enable operation.

A further aspect of the present disclosure provides that the sheath has at least a first tool interface and/or gripping surface at a first end of the plug connector which faces away from the contact. The tool interface and/or gripping surface may, for example, be a hexagon or key surfaces and/or specially roughened surfaces and/or wings (as in the case of a wing nut). Of course, this is not to be understood in a restrictive way. Other types of actuating elements or connection techniques are also conceivable.

Due to the arrangement of the tool interface or gripping surface remote from the contact, the engagement level for manual and/or tool-based making, releasing and/or securing of the plug connector is shifted towards the cable end thereof, which generally simplifies operation. The cable end of the plug connector corresponds to the end at which the plug connector cable is inserted into the sheath.

In a further variant, the sheath has at least one second tool interface and/or gripping surface at a second end of the plug connector, which faces the contact. Preferably, the first and the second tool interface and/or gripping surface are located on opposite sides of the plug connector.

In other words, two spaced-apart operating levels are provided. For tool-based or manual establishing, releasing and/or securing of the plug connection, it is then for example possible to use the more accessible one of the two operating levels depending on the application, i.e. at the top or bottom or in the area of the plug connector cable or away therefrom.

However, it is also conceivable that the plug connector is pre-fixed using the first tool interface and/or gripping surface (remote from the contact) and then tightened using the second tool interface and/or gripping surface (close to the contact).

A contact can thus be easily established first. The retightening is then carried out via the tool interface close to the contact to avoid greater bending moments on the contact area of the plug connector due to the retightening force. The plug connection produced can be secured due to the retightening.

In a preferred embodiment, the sheath has a first guiding element, which is arranged on an inner side of the sheath and which rotatably and/or displaceably rests against the contact carrier.

The guiding element can be used to ensure that the sheath can only be moved in a designated path relative to the contact carrier. The guiding element thus ensures an accurate establishing, releasing and/or securing of the plug connection.

For example, the guiding element may be designed as a circular web having a central opening. A cylindrical contact carrier can thus be easily guided axially within the opening on the inner wall thereof.

This type of guiding allows both a rotational movement of the sheath relative to the contact carrier and a linear translational movement of the two parts. With this configuration of the guiding element, it is therefore possible to establish, release and/or secure the plug connection contact by means of a screw connection, a push-pull mechanism or a bayonet mechanism.

The push-pull mechanism may be, for example, a mechanism for factory automation plug connectors, as described in the standards IEC 61076-2-010, IEC 61076-2-012.

In a further variant of the present disclosure, the sheath has at least one second guiding element. It is also arranged on an inner side of the sheath and rotatably and/or displaceably rests against the contact carrier. The first guiding element and the second guiding element are arranged spaced apart from each other in the longitudinal direction of the plug connector.

The second guiding element or the interaction of the at least two guiding elements leads to an even better guidance of the sheath on the contact carrier.

A further aspect of the present disclosure provides that the sheath has a connecting element, in particular an internal thread or an external thread or a push-pull connector at a second end of the plug connector which faces the contact. In this way, a secure contact to a corresponding plug connector counterpart can be established quickly and easily by moving the sleeve accordingly.

Optionally, a vibration protection element may also be provided, for example a latching mechanism between the sheath and the contact carrier. The vibration protection element is used to secure the plug connection against vibrations and to prevent unintentional loosening or release of the plug connection.

It is furthermore conceivable that the sheath has a rubber coating on at least part of its outer surface. This in particular improves manual operability. Even with higher torsional forces applied, a secure grip of the sheath is ensured.

It may also be provided that the plug connector has a sealing element which is firmly arranged on the contact carrier and which is designed to connect the contact carrier in a sealing manner to a plug connector cable. The sealing element is arranged at least partially inside the movable sheath.

The sealing element serves to seal the cable. It may also provide strain relief for the plug connector. The arrangement within the sheath protects the sealing element from possible external mechanical interferences.

### BRIEF DESCRIPTION OF THE DRAWINGS

Further features and advantages of the present disclosure will become apparent from the description below and from the drawings, to which reference is made and in which:

FIG. 1 shows a schematic representation of plug connectors known from the prior art;

FIG. 2 shows a schematic representation of a first embodiment of a plug connector according to the invention;

FIG. 3 shows a schematic representation of a second embodiment of a plug connector according to the invention; and

FIG. 4 shows a schematic representation of a third embodiment of a plug connector according to the invention with a sheath designed as an adapter.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

For the purposes of the present disclosure, the phrase “at least one of A, B, and C”, for example, means (A), (B), (C), (A and B), (A and C), (B and C), or (A, B, and C), including all further possible permutations when more than three elements are listed. In other words, the term “at least one of A and B” generally means “A and/or B”, namely “A” alone, “B” alone or “A and B”.

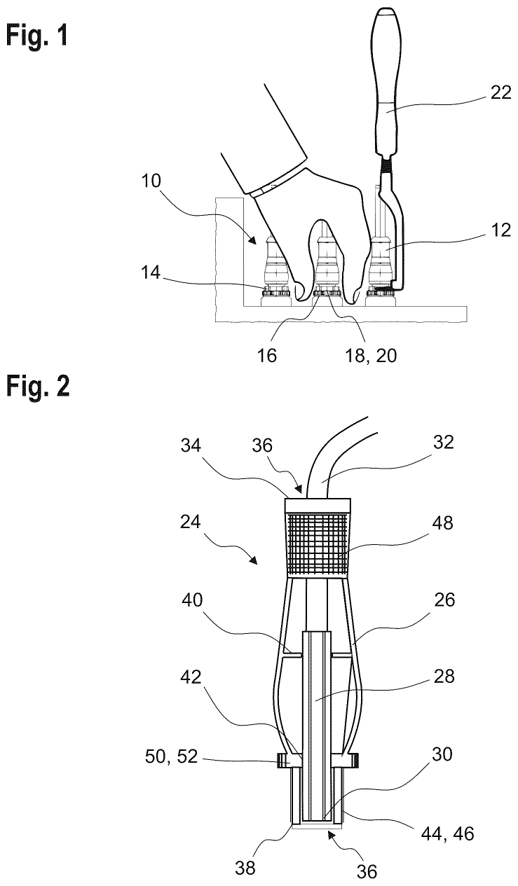

FIG. 1 shows a schematic representation of conventional plug connectors 10 known from the prior art.

They each comprise a housing 12, which is firmly connected to a contact carrier (not shown) located inside.

A threaded sleeve 14 with an internal thread, which can be screwed onto a corresponding counterpart (not shown) to establish and/or secure a plug connection is arranged at the lower end of each conventional plug connector 10.

On their outer side, the threaded sleeves 14 of the conventional plug connectors 10 shown each have a knurl 16 for manual screwing and a hexagonal contour 18, which serves as a tool application point 20.

A corresponding tool 22, in this case a torque wrench, can grip the threaded sleeve 14 via the hexagonal contour 18 and screw it securely by a rotary movement.

The conventional plug connectors 10 shown in FIG. 1 are characterized by the fact that the threaded sleeves 14 are located at the plug connector ends via which the plug connections are established (the lower plug connector ends in the figure). The threaded sleeve 14 is thus configured so as to be rotatable relative to the housing 12 (and to the contact carrier firmly connected to the housing 12).

As shown schematically in FIG. 1, the space available for gripping or rotating a threaded sleeve 14 is severely restricted by the adjacent conventional plug connectors 10, so that screwing by hand or using the tool 22 is difficult.

FIG. 2 shows a schematic representation of a first embodiment of a plug connector 24 according to the invention, which offers a simplified way of establishing or securing a plug connection.

In the embodiment shown, the plug connector 24 is designed as a circular plug connector and comprises a sheath 26 and a cylindrical contact carrier 28 having a plurality of electrical contacts 30.

The sheath 26 extends over the entire length of the plug connector 24 and completely surrounds the contact carrier 28. In this respect, the sheath 26 surrounds the contact carrier 28.

In the example embodiment, the sheath 26 is formed in one piece and is therefore mechanically particularly stable. For example, the sheath 26 can be an injection-molded part, a turned part, a die-cast part, in particular a zinc die-cast part, or a 3D-printed component made of a plastic or a metal.

In the plug connector 24, the contact carrier 28 or the contacts 30 merge into a plug connector cable 32. At a first end 34 of the plug connector 24 (the upper end in FIG. 2), the sheath 26 has an opening 36 (at the end face) through which the plug connector cable 32 is passed.

At an opposite second end 38 of the plug connector 24 (the lower end in FIG. 2), the sheath 26 also has an opening 36 (at the end face) through which the contacts 30 are accessible to form an electrical connection when plugged into a counterpart.

In contrast to the prior art, the sheath 26 and the contact carrier 28 of the plug connector 24 are movable relative to each other.

In the example embodiment, the sheath 26 can rotate around the contact carrier 28. It can also be displaced in the axial direction relative to the contact carrier 28.

The sheath 26 has a first guiding element 40, which is arranged on an inner side of the sheath 26 to ensure directional movement.

In the example embodiment, the first guiding element 40 is a web or a (partial) disk, which extends from the inner side of the sheath 26 to the contact carrier 28.

In its center, the first guiding element 40 has an opening through which the cylindrical contact carrier 28 is guided. The contact carrier 28 is rotatable and axially displaceable with respect to the guiding element 40. It can also rest against the guiding element 40, as a result of which the guiding element 40 forms a corresponding bearing for the contact carrier 28.

The plug connector 24 shown in FIG. 2 also has a second guiding element 42, which is also arranged on an inner side of the sheath 26 and which is rotatable and/or displaceable with respect to the contact carrier 28. The second guiding element 42 can also form a bearing for the contact carrier 28, so that the contact carrier 28 rests against the second guiding element 42.

The first and the second guiding element 40, 42 are arranged spaced apart from each other in the longitudinal direction of the plug connector 24. This prevents the sheath 26 from tilting relative to the contact carrier 28, even if lateral forces act on the plug connector 24.

At the second (lower) end 38 of the plug connector 24, the sheath 26 has a connecting element 44. In the example embodiment, the connecting element 44 is an external thread 46 which surrounds the lower area of the sheath 26.

The connecting element 44 is configured to be connected to a corresponding counterpart (not shown). For example, the counterpart can be a socket having a corresponding internal thread, into which the external thread 46 can be screwed by a rotary movement of the sheath 26 to produce a plug and screw connection, as a result of which a plug connection produced is secured.

Of course, the example given is not to be understood in a restrictive way. Other types of connecting elements 44, in particular internal threads, bayonet locks and/or push-pull connectors are also conceivable.

The sheath 26 has a gripping surface 48 at the first (the upper) end 34 of the plug connector 24 to move the sheath 26 relative to the contact carrier 28 such that a plug connection can be established, for example by an axial translational movement and/or a rotary movement.

In the example embodiment, this is a roughened surface of the sheath 26, which provides a good grip during manual actuation, for example a knurl. The sheath 26 can therefore be easily gripped by hand at the upper, easily accessible end 34 of the plug connector 24 and rotated to screw the connecting element 44 into the corresponding counterpart and thus establish or secure a plug connection.

Furthermore, the sheath 26 also has a tool interface 50 at the second (lower) end of the plug connector. In the example embodiment, it is designed as a hexagonal geometry 52. A torque wrench can for example be applied to the hexagonal geometry 52 to fasten the sheath 26 to the counterpart with a defined force and/or to retighten a previously performed manual fastening.

Of course, the sheath 26 can also have more than two tool interfaces 50 and/or gripping surfaces 48. For example, a hexagonal geometry 52 may also be provided at the first (the upper) end 34 of the sheath 26.

It is also conceivable that the sheath 26 has a hexagonal geometry 52 at the first (the upper) end 34 and a knurl 16 at the second (the lower) end 38.

Furthermore, other types of tool interfaces 50 and/or gripping surfaces 48 are also possible. For example, wings (not shown) which extend in the circumferential direction of the plug connector 24 may be provided on the outer circumference of the sheath 26 as in a wing nut. This allows higher torques to be transmitted to the sheath 26 by hand without causing slipping.

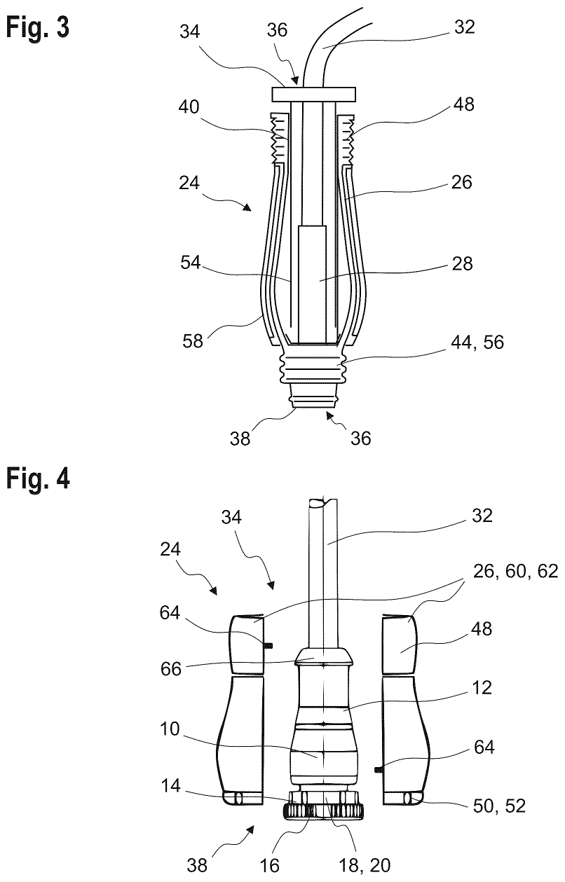

FIG. 3 shows a second example embodiment of a plug connector 24 according to the invention, which corresponds to the first example embodiment in several essential aspects, so that only the differences will be discussed below. Identical or functionally identical elements are labeled with the same reference numerals.

The plug connector 24 shown in FIG. 3 also has a contact carrier 28 and a sheath 26 which is movable relative to the contact carrier 28.

The contact carrier 28 is in some areas arranged in a tube 54 which protects it from mechanical stress. The contact carrier 28 and the tube 54 are firmly connected to each other.

Within the tube 54, the contact carrier 28 or the contacts (not shown) thereof merge into a plug connector cable 32, which leaves the plug connector 24 at a first end 34 (the upper end in FIG. 3).

The sheath 26 has a smooth inner surface in a region of the plug connector 24 (at the upper end in FIG. 3), which rests against the outer circumference of the tube 54 and serves as a guiding element 40.

At a second end 38 of the plug connector 24 (the lower end in FIG. 3), the sheath 26 has a connecting element 44, which is designed as a push-pull connector 56.

By an axial translational movement of the sheath 26 relative to the contact carrier 28, the push-pull connector 56 can be latched with a counterpart (not shown) to thus form and/or secure a plug connection.

Of course, the plug connector 24 can also be released from the counterpart again with a suitable translational movement of the sheath 26.

Furthermore, the sheath 26 has a gripping surface 48 at the first (the upper) end 34 of the plug connector 24, by means of which the sheath 26 can be gripped and moved relative to the contact carrier 28 to thus establish, secure or release a plug connection.

In the example embodiment, the sheath 26 also has an outer circumferential rubber coating 58, which also serves to improve operability or manual gripping.

It is also conceivable that the plug connector 24 has a push-pull connector 56 to form a plug connection, which is then secured by rotating the plug connector 24. For this purpose, the plug connector 24 can then additionally have an external thread 46, as already explained above with reference to FIG. 2.

FIG. 4 shows a third embodiment of a plug connector 24 according to the invention with a sheath 26 designed as an adapter 60. Here too, the following description will only focus on the differences to the embodiments described above. Identical and/or functionally identical parts are labeled with the same reference numerals.

The plug connector 24 according to the invention shown in FIG. 4 comprises a conventional plug connector 10 known from the prior art and a sheath 26 designed as an adapter 60.

In the embodiment shown, the sheath 26 comprises two sheath halves 62, which can be coupled via latching mechanisms 64. However, it is in principle also possible to provide a plurality of sheath parts.

The two sheath halves 62 each extend in the axial direction of the plug connector 24 over almost the entire length of the plug connector.

The sheath halves 62 can be placed as individual parts on the conventional plug connector 10 and then connected to each other by means of the latching mechanisms 64 such that the sheath 26 fully encloses the conventional plug connector 10.

In the example embodiment, the sheath 26 has a hexagonal inner geometry (not shown) at a second end 38 of the plug connector 24 (the lower end in FIG. 4), which engages in a hexagonal (outer) contour 18 of a threaded sleeve 14 of the conventional plug connector 10. This firmly connects the sheath 26 to the threaded sleeve 14.

As a result, when the sheath 26 is moved, the threaded sleeve 14 of the conventional plug connector 10 is also moved accordingly, as a result of which a plug connection with a corresponding counterpart can be established, secured or released.

The sheath 26 also has a gripping surface 48 at the first end 34 of the plug connector 24 (the upper end in FIG. 4) and a tool interface 50 at a second end 38 of the plug connector 24 (the lower end in FIG. 4), which is designed as a hexagonal geometry 52.

The plug connector 24 shown in FIG. 4 also comprises a sealing element 66, which serves to seal and provide strain relief for the plug connector cable 32 and is firmly connected to the contact carrier (not shown) of the plug connector 24.

In the example embodiment, the sealing element 66 is arranged completely inside the movable sheath 26 and is thus protected from possible mechanical interferences.

The arrangement shown also has the advantage that, by means of the adapter 60, the operating level for establishing, securing and/or releasing the plug connection can be moved upwards from the second end 38 (in FIG. 4 the lower end forming the contact) beyond the first end 34 of the conventional plug connector 10 (in FIG. 4 the upper end on the cable side).

Particularly good accessibility is thus achieved.

Certain embodiments disclosed herein, particularly the respective module(s) and/or unit(s), utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used.

In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes one or more processors or portions thereof and accompanying software, firmware, hardware, and the like.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about”, “approximately”, “near” etc., mean plus or minus 5% of the stated value.

List of reference numerals

| Reference numeral | designation |
|---|---|
| 10 | conventional plug connector |
| 12 | housing |
| 14 | threaded sleeve |
| 16 | knurl |
| 18 | hexagonal contour |
| 20 | tool application point |
| 22 | tool |
| 24 | plug connector according to the invention |
| 26 | sheath |
| 28 | contact carrier |
| 30 | contact |
| 32 | plug connector cable |
| 34 | first end |
| 36 | opening |
| 38 | second end |
| 40 | first guiding element |
| 42 | second guiding element |
| 44 | connecting element |
| 46 | external thread |
| 48 | gripping surface |
| 50 | tool interface |
| 52 | hexagonal geometry |
| 54 | tube |
| 56 | connector |
| 58 | rubber coating |
| 60 | adapter |
| 62 | sheath half |
| 64 | latching mechanism |
| 66 | sealing element |

1. A plug connector for forming a plug connection, comprising a sheath which is designed to extend at least almost over an entire length of the plug connector and to move relative to a contact carrier of the plug connector, the sheath having at least one opening through which a plug connector cable can be passed, which merges into at least one contact provided on the contact carrier.

2. The plug connector according to claim 1, wherein the sheath is designed as an adapter which can be placed on the plug connector such that the sheath fully encloses the plug connector.

3. The plug connector according to claim 1, wherein the sheath is designed in several parts, so that several sheath parts are provided which can be coupled to each other.

4. The plug connector according to claim 1, wherein the sheath is formed in one piece over the entire length of the plug connector.

5. The plug connector according to claim 1, wherein the sheath comprises at least a first tool interface and/or gripping surface at a first end of the plug connector which faces away from the contact.

6. The plug connector according to claim 1, wherein the sheath comprises at least a second tool interface and/or gripping surface at a second end of the plug connector which faces the contact.

7. The plug connector according to claim 1, wherein the sheath has a first guiding element which is arranged on an inner side of the sheath and which rotatably and/or displaceably rests against the contact carrier.

8. The plug connector according to claim 7, wherein the sheath has at least one second guiding element which is arranged on an inner side of the sheath and which rotatably and/or displaceably rests against the contact carrier, wherein the first guiding element and the second guiding element are arranged spaced apart from each other in a longitudinal direction of the plug connector.

9. The plug connector according to claim 1, wherein the sheath has a connecting element at a second end of the plug connector which faces the contact.

10. The plug connector according to claim 9, wherein the connecting element is an internal thread or an external thread or a push-pull connector.

11. The plug connector according to claim 1, comprising a sealing element which is fixedly arranged on the contact carrier and is designed to connect the contact carrier in a sealing manner to the plug connector cable, the sealing element being arranged at least partially inside the movable sheath.
